(19) United States
(12) Patent Application Publication
(10) Pub. No.: US 2008/0085501 A1
(43) Pub. Date: Apr. 10, 2008

(54) System and methods for interactive assessment of performance and learning

(75) Inventors: Dennis H. Novack, Penn Valley, PA (US); Christof J. Daetwyler, Philadelphia, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: PHILADELPHIA HEALTH & EDUCATION CORPORATION, Philadelphia, PA (US)

(21) Appl. No.: 11/545,378

(22) Filed: Oct. 10, 2006

(51) Int. Cl. G09B 3/00

(52) U.S. Cl. 434/322

(57) ABSTRACT

Systems and methods provide a computer-implemented interactive system and methods allowing the interactive assessment of performance and learning. In an illustrative implementation, a computing environment comprises a data store having content for dissemination to participating users as part of an education/training program, and an assessment engine having facilities to allow the real-time storage and monitoring of a test session engaged in by a participating user in which the participating user can demonstrate knowledge of selected subject matter through the interaction, in real time, using video/audio teleconferencing, with one or more cooperating parties. In an illustrative operation, participating users are provided access to the exemplary computing environment as part of an e-learning application providing learning content to the user. Participating users can interact in real time with cooperating parties as part of an assessment process of the user. Such interaction can be realized through computer enabled video/audio teleconferencing.

### BACKGROUND

The proliferation of electronic communication has lead to the development of various virtual applications that have been used to enhance or replace conventional practices. Included in these applications are “electronic learning” (e-learning) offerings that allow for the dissemination of educational materials (e.g., coursework, training materials, references, etc.) to a large number of participating users without regard to geography and, in some instances, aptitude. Some e-learning applications also provide tools, features, and/or operations to allow the educator (or trainer) the ability to evaluate the performance of the participating user as they progress through a defined course (or training program). In this context, current practices generally utilize the administration of tests to test the knowledge of the participating user on the educational (or training materials) being provided to the participating user.

Such tests are generally static in nature (i.e., non interactive) having questions (e.g., multiple choice or essay) for which the participating users provide answers during a test taking session. The tests may include multi-media content to provide context to a particular question or set of questions. Additionally, the results of the test session can be stored and processed to generate a quantitative measure of the participating user's knowledge of particular content delivered to the participating users.

However, with current applications there does not exist a facility, features, and/or operations to allow the educator to perform an interactive assessment of participating users as a test is being administered as part of a defined test session. In this context, current practices fail to provide systems and methods to allow educators (or trainers) to evaluate (or monitor) the performance of a participating user as they perform one or more selected procedures (e.g., engaging by the participating user a cooperating party, playing the role of a patient, using virtual teleconferencing in a patient interview to demonstrate to the educator/trainer that the participating user has learned how to properly administer a patient interview).

Additionally, current offerings fail to provide a facility, feature, and/or operation to allow participating users to record in real-time their test session for use as reference as part of future test sessions and/or as reference to assist the participating user in re-learning provided content. Furthermore, current practices do not allow educators (or trainers) the ability to share evaluations among each other (e.g., shared checklists) as part of the process of evaluating the performance and/or learning of participating users. Te use of non-collaborative evaluations with current applications can lead to imprecise and skewed evaluations of the participating user from one or more educators (or trainers).

From the foregoing, it is appreciated that there exists a need for systems and methods that are aimed to ameliorate the shortcomings of existing practices.

### SUMMARY

The herein described systems and methods provide a computer-implemented interactive system and methods allowing the interactive assessment of performance and learning. In an illustrative implementation, a computing environment comprises a data store having content for dissemination to participating users as part of an education/training program, and an assessment engine having facilities to allow the real-time storage and monitoring of a test session engaged in by a participating user in which the participating user can demonstrate defined communication skills and knowledge of selected subject matter through the interaction, in real time, using video/audio teleconferencing, with one or more cooperating parties.

In an illustrative operation, participating users are provided access to the exemplary computing environment as part of an e-learning application obtaining information as part of a learning exercise and be assessed on the level of learning by the participating user. In the illustrative implementation, the computing environment can comprise video/audio teleconferencing capabilities to allow participating users the ability to communicate through the computing environment to cooperating parties. In the illustrative operation, the participating user can interact, in real time, using the exemplary computer enabled video/teleconferencing features with the cooperating parties as part of a test/assessment session in which the participating user can perform one or more selected procedures for which the user can be evaluated/assessed by a content provider (e.g., educator/trainer/certification specialist).

In an illustrative implementation, the computing platform can comprise a computing application having one or more instructions to guide an interactive assessment process which allows content providers (e.g., educators/trainers) the ability to assess through the use of the computing environment interactions between participating users and cooperating parties. The application can include but is not limited to the following features: recording of assessment sessions for subsequent use, shared checklists between various content providers to allow to support more comprehensive assessment, the use of model scenarios which provide instruction to the participating user as a guide when engaging in one or more interactions with cooperating parties.

Other features of the herein described systems and methods are further described below.

### BRIEF DESCRIPTION OF THE DRAWINGS

The interactive systems and methods for interactive assessment of performance and learning are further described with reference to the accompanying drawings in which:

FIG. 1 is a block diagram of an exemplary computing environment in accordance with an implementation of the herein described systems and methods;

FIG. 2 is a block diagram showing the cooperation of exemplary components of an illustrative implementation in accordance with the herein described systems and methods;

FIG. 3 is a block diagram showing the cooperation of exemplary components of another illustrative implementation in accordance with the herein described systems and methods;

FIG. 4 is a block diagram showing an illustrative block representation of an illustrative interactive learning/assessment system in accordance with the herein described systems and methods;

FIG. 5 is flow diagram showing illustrative processing performed to allow the interactive evaluation of performance and learning in accordance with the herein described systems and methods; and

FIG. 6 is flow diagram showing another illustrative processing performed to allow the interactive evaluation of performance and learning in accordance with the herein described systems and methods.

### DETAILED DESCRIPTION

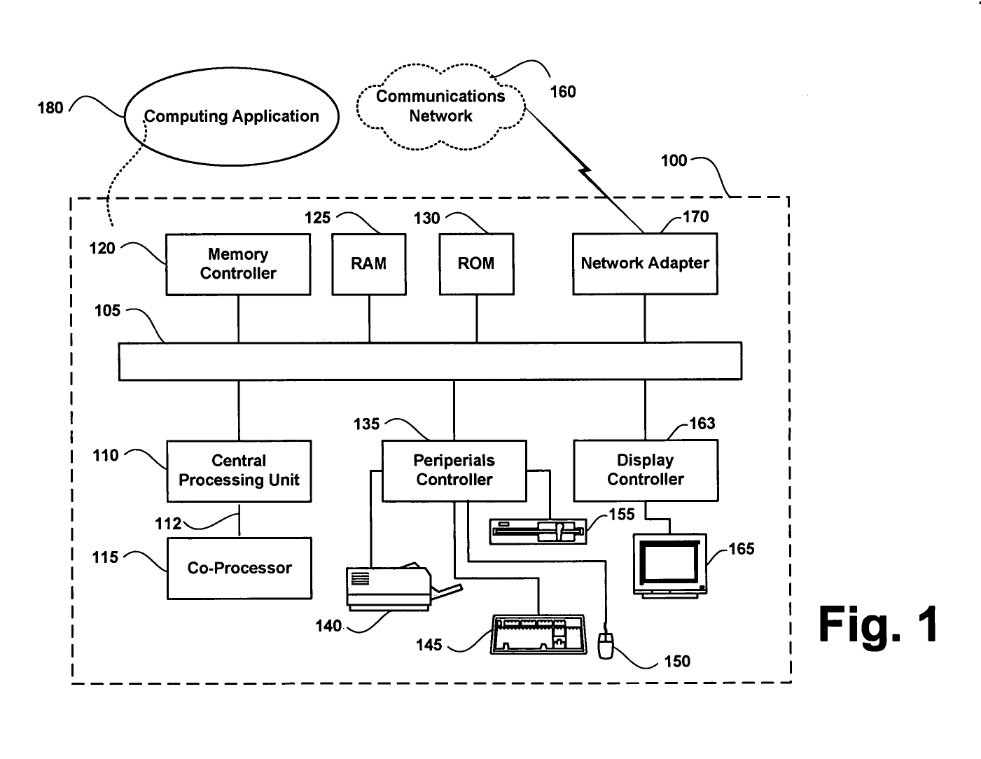

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communication network 160.

### Illustrative Computer Network Environment:

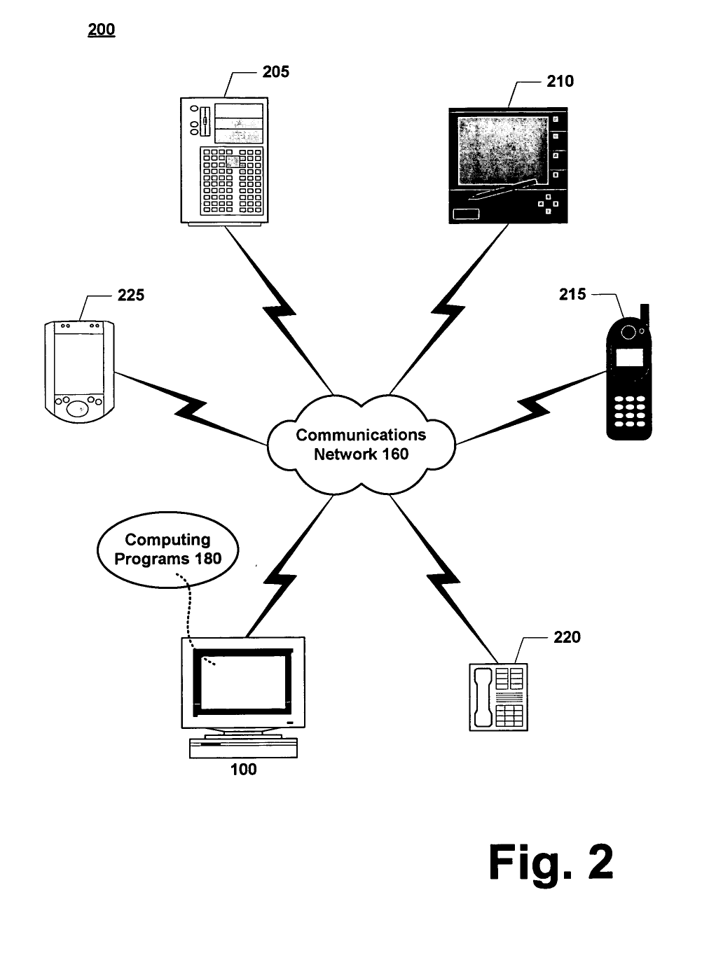

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

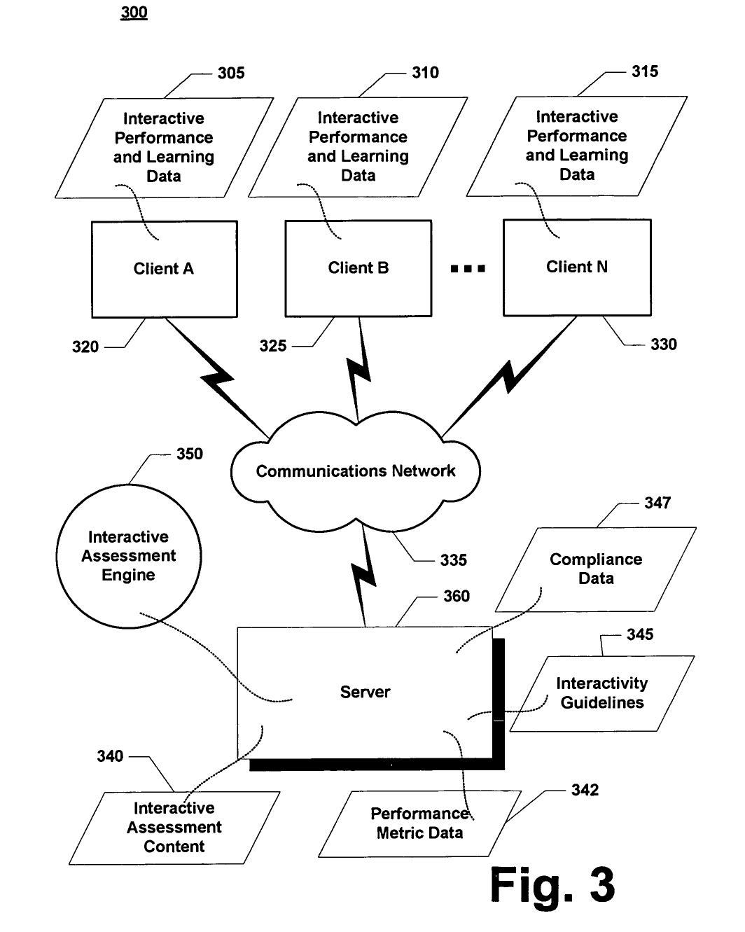

FIG. 3 shows an illustrative implementation of exemplary interactive assessment platform 300. As is shown in FIG. 3, exemplary interactive assessment platform 300 comprises client computing environment 320, client computing environment 325 up to and including client computing environment 330, communications network 335, server computing environment 360, interactive assessment engine 350, interactive assessment content 340, performance metric data 342, interactivity guidelines 345, and compliance data 347. Also, as is shown in FIG. 3, interactive assessment platform can comprise a plurality of interactive performance and learning data (e.g., model scenarios) 305, 310, and 315 which can be displayed, viewed, electronically transmitted and printed from client computing environments 320, 325, and 330, respectively.

In an illustrative operation, client computing environments 320, 325, and 330 can communicate and cooperate with server computing environment 360 over communications network 335 to provide requests for and receive interactive performance and learning data information 305, 310, and 315. In the illustrative operation, interactive assessment engine 350 can operate on server computing environment 360 to provide one or more instructions to server computing environment 360 to process requests for interactive performance and learning data 305, 310, and 315 and to electronically communicate interactive performance and learning data 305, 310, and 315 to the requesting client computing environment (e.g., client computing environment 320, client computing environment 325, or client computing environment 335). As part of processing requests for interactive performance and learning data 305, 310, and 315, interactive assessment engine 350 can utilize a plurality of data comprising interactive assessment content 340 and compliance data 345. Also, as is shown in FIG. 3, client computing environments 320, 325, and 330 are capable of processing interactive performance and learning data 305, 310, and 315 for display and interaction to one or more participating users (not shown).

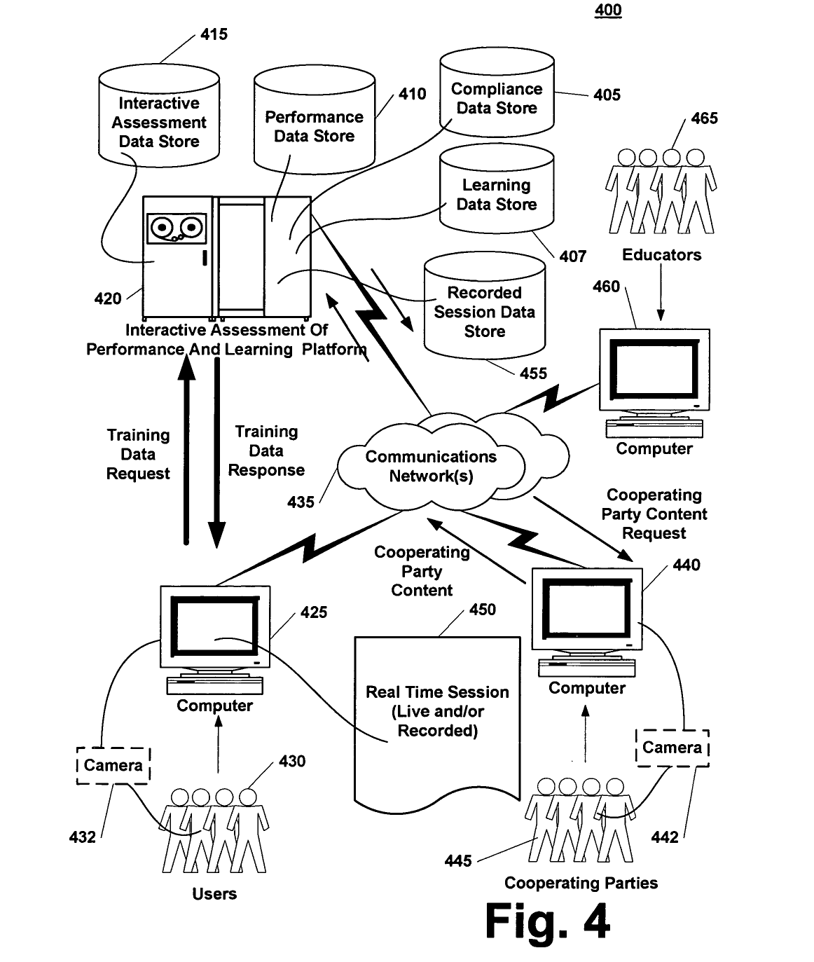

FIG. 4 shows a detailed illustrative implementation of interactive learning//assessment environment 400. As is shown in FIG. 4, exemplary interactive learning/assessment environment 400 comprises interactive assessment of performance and learning platform 420, interactive data store 415, performance data store 410, compliance data store 405, learning data store 407, and recorded session data store 455, user computing environment 425, users 430, cooperating party computing environment 440, cooperating parties 445, educator computing environment 460, and educators 465. Additionally, as is shown in FIG. 4, interactive assessment environment 400 can comprise real time assessment session content (e.g., live and/or recorded) 450 which can be displayed, viewed, transmitted and/or printed from user computing environment 425, cooperating party computing environment 440, and/or educator computing environment 460. Further as is shown, user computing environment and cooperating party computing can cooperate with cameras 432 and 442 respectively as part of a computer enabled video-teleconferencing operation.

In an illustrative implementation, interactive assessment platform 420 can be electronically coupled to user computing environment 425, cooperating party computing environment 440, and educator computing environment 460 via communications network 435. In the illustrative implementation, communications network can comprise fixed-wire and/or wireless intranets, extranets, and the Internet.

In an illustrative operation, users 430 can interact with interactive assessment interface (not shown) operating on user computing environment 425 to provide requests to initiate an interactive assessment session that are passed across communications network 435 to interactive assessment platform 420. In the illustrative operation, interactive assessment platform 420 can process requests for an interactive assessment session and cooperate with interactive assessment data store 415, performance data store 410, compliance data store 405, learning data store, and recorded session data store 455 to generate an interactive assessment session (e.g., including interactive learning/assessment electronic content) for use by users 430, cooperating parties 445, and educators 465.

In an illustrative implementation, interactive assessment data store 415 can comprise model scenario content provided by one or more educators relating to one or more selected subjects. Such data can include but is not limited to digital content that can be used to provide instruction to users 430 regarding the execution of one or more selected procedures (e.g., how to perform specific skills in a complex patient interview by a doctor). In the illustrative implementation, performance data store 410 can comprise data representative of a participating user's performance in previously engaged interactive assessment session. Compliance data store 405 can comprise data representative of the threshold requirements to grant certification for the proper execution of a selected procedure as part of a model scenario. Recorded session data store 455 can comprise data representative of previously engaged interactive assessment sessions that have been recorded for use in re-learning one or more aspects of a given procedure.

In the illustrative operation, exemplary interactive learning/assessment environment 400 can provide learning data from learning data store 407 to participating users 430 as part of a learning exercise. In an illustrative implementation, learning data store 407 can comprise data representative of one or more learning exercises (e.g., how to survive a medical school interview, how to sell cosmetics, how to give a patient distressing news, etc.) engaged in by participating users 430 as part of a selected curriculum. In the illustrative operation, exemplary learning/assessment environment 400 can operate to provide content from learning data store 407 for learning by participating users 430 and subsequently evaluate the degree of learning using interactive assessment of performance and learning platform 420.

In the illustrative operation, responsive to the requests from users 430 for an interactive assessment session, interactive assessment platform 420 can process the requests and cooperate with one or more of the environment stores to initiate, monitor, and record and interactive assessment session used to assess/evaluate the aptitude and/or skills of a participating user when executing one or more selected procedures. In the illustrative implementation, cooperating party computing environment 440 can comprise a computing environment for use by role players to engage the participating user (e.g., using computer enabled vide/audio teleconferencing operations) as part of executing one or more selected parts of a model scenario (e.g., executing one or more procedures). Furthermore, in the illustrative implementation, educator computing environment 460 can be used by educators 465 to electronically monitor, track, and grade (e.g., in real time or post-facto) a participating user as the user interacts with one or more cooperating parties 445 as part of the interactive assessment session.

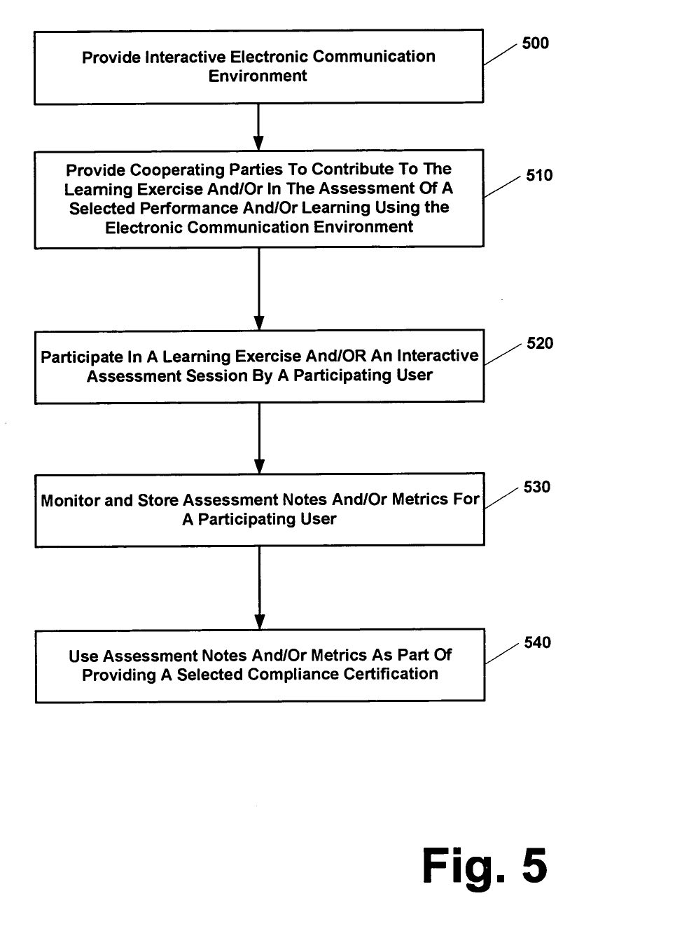

FIG. 5 shows exemplary processing performed when using an illustrative implementation of interactive assessment environment 400 of FIG. 4. As is shown, processing begins at block 500 where an interactive electronic communication environment is provided. In an illustrative implementation, the exemplary interactive electronic communication environment can comprise a client server computing environment having computer enabled video/audio teleconferencing capabilities. Processing then proceeds to block 510 where cooperating parties are provided to contribute to the learning/assessment of a selected performance and/or learning of a participating user using the exemplary electronic communication environment. In an illustrative implementation, the cooperating parties can comprise actors who play a selected role of a model scenario so as to interact with a participating user in an exemplary assessment session that can be initiated to test the aptitude and/or skill of the participating user as the user follows the model scenario (e.g., degree of knowledge of learning data provided to the participating user).

From block 510, processing proceeds to block 520 where a participating user engages in an interactive learning/assessment session (e.g., participate in an learning exercise and/or assessment session). Processing then proceeds to block 530 where assessment notes and/or metrics are monitored and/or stored for the participating user engaging in an interactive assessment session. The assessment notes and/or metrics can then be used to determine whether the participating user has the requisite aptitude and/or skill required to comply with selected standards so as to warrant certification for a particular skill.

In an illustrative implementation, the processing of FIG. 5 can be used to determine whether a medical student has learned the requisite clinical skills to conduct a patient interview (as part of a differential diagnosis). In the illustrative implementation, the medical student can employ the exemplary electronic communications environment having video/audio teleconferencing capabilities to engage, in real time and remotely, a cooperating party who is playing the role of a patient. In the illustrative implementation, the interaction between the medical student and the actor patient can be electronically monitored by an educator (e.g., trainer) as part of an assessment session to determine whether the medical student has the requisite skills to warrant required certification to allow the medical student to advance in their studies. In addition to electronically monitoring, the herein described systems and methods, in an illustrative implementation, can operate to record the assessment session for future use, allow shared checklists between various educators to provide comprehensive assessment and evaluation of the medical student (e.g., one educator can assess one portion of the interaction while another educator/trainer can assess other portions of the interaction). Additionally, in the illustrative implementation, the electronic communication environment supporting the interactive assessment can operate to provide model scenario content to the participating user as part of their education and/or learning prior to and/or after an interactive assessment session.

It is appreciated, that although an illustrative implementation is provided herein describing the use of the herein described systems and methods in the context of certifying clinical skills of a medical student that such description is merely illustrative as the inventive concepts described herein can be used in various assessments and certifications including but not limited to police training and certification, sales training and certification, etc.

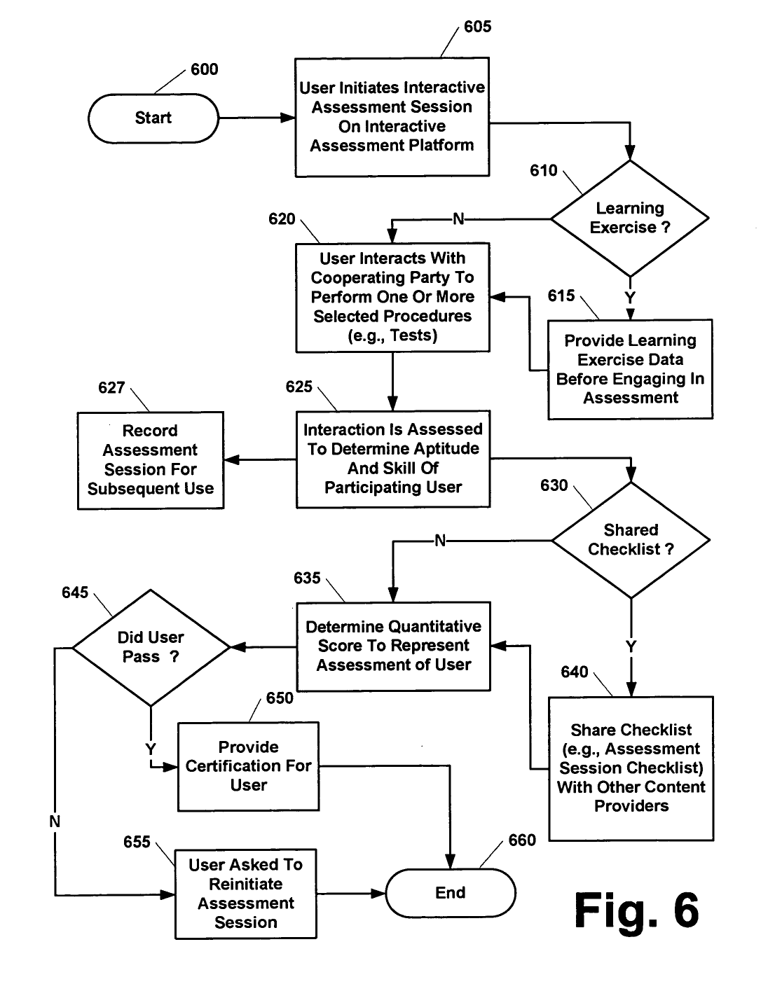

FIG. 6 shows other processing performed by an exemplary interactive assessment environment 400 of FIG. 4. As is shown, processing begins at block 600 and proceeds to block 605 where a user can initiate an interactive assessment session on interactive assessment platform. From there processing proceeds to block 610 where a check is performed to determine if a learning exercise is to be presented to the participating user as part of the interactive learning/assessment session. If the check at block 610 indicates that learning exercise is to be provided, processing proceeds to block 615 where learning data content is retrieved and delivered electronically to the participating user. Processing then proceeds to block 620.

However, if at block 610 the check indicates that a learning exercise (e.g., a model scenario) is not to be provided to the participating user, processing proceeds to block 620 where the participating user interacts with a cooperating party (e.g., electronically using computer enable video/audio teleconferencing and other electronic communication instrumentalities) to perform one or more selected procedures (e.g., tests). Processing then proceeds to block 625 where the interaction between the participating user and the cooperating party is assesses (e.g., electronic monitoring and evaluation) to determine the aptitude and/or skill of the participating user. The interactive assessment session can then be recorded at block 627. Also, from block 625, processing can proceed to block 630 where a check is performed to determine if the interactive assessment is to be realized through a shared checklist. If the check at block 630 indicates that the assessment checklists are to be shared, processing proceeds to block 640 where the assessment checklist is shared with other content providers (e.g., educators/trainers). From there processing proceeds to block 635.

However, if the check at block 630 indicates that there are to be no shared checklists, processing proceeds to block 635 where a quantitative score representing the assessment is determined. A check is then performed at block 645 to determine if the user has met threshold requirements to earn a passing score (e.g., certification) for the procedures performed by the participating user. If the check at block 645 indicates that the participating user has achieved a passing score, processing proceeds to block 650 where the certification is provided to the user indicating that the use has attained the requisite skills and/or aptitude to perform a selected procedure. Processing then terminates at block 660.

However, the check at block 645 indicates that the participating user has not achieved a passing score, processing proceeds to block 655 where the participating user is asked to re-learn the selected procedure for which the participating user is being assessed and reinitiate an interactive assessment session. Processing then terminates at block 660.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments, including cell phones and video phones), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A computer-implemented interactive method providing interactive learning/assessment of performance and learning comprising:
providing a graphical user interface operable to receive and display interactive learning/assessment session information;
receiving data from the graphical user interface representative of a participating user's execution of one or more selected portions of a model scenario as executed in an interactive session with one or more cooperating parties; and
electronically assessing the performance of the participating user to generate one or more assessment metrics.

2. The method as recited in claim 1 further comprising generating a quantitative representation of the generated one or more assessment metrics.

3. The method as recited in claim 2 further comprising comparing the generated quantitative representation with a selected threshold value to determine whether the aptitude and/or skill of the participating user warrants a selected certification.

4. The method as recited in claim 3 further comprising providing the certification to the participating user if generated quantitative representation meets and/or exceeds the selected threshold value.

5. A computer-readable medium that contains instructions which, when executed by a processor, causes the processor to perform an interactive method providing an interactive assessment session comprising the steps of:
providing a graphical user interface operable to receive and display interactive learning/assessment session information;
receiving data from the graphical user interface representative of a participating user's execution of one or more selected portions of a model scenario as executed in an interactive session with one or more cooperating parties; and
electronically assessing the performance of the participating user to generate one or more assessment metrics.

6. A method to generate an assessment of a selected performance:
electronically providing to a participating user a model scenario representative of exemplary procedures to be followed;
electronically observing the interaction between the participating user and a cooperating party to determine whether the participating user has complied with the exemplary procedures provided in the model scenario;
electronically recording the interaction between the participating user and the cooperating party; and
generating an assessment metric for the participating user based on the observed interaction.

7. The method as recited in claim 6 further comprising providing computer enabled video/audio teleconferencing instrumentalities to the participating user to facilitate the interaction with the cooperating party.

8. The method as recited in claim 7 further comprising generating a quantitative representation of the assessment metric for use in a certification process.

9. The method as recited in claim 6 further comprising providing a checklist for use in the assessment of the participating user.

10. The method as recited in claim 9 further comprising sharing the checklists among two or more educators when generating the assessment metric.

11. A system for interactive assessment of performance and/or learning comprising:
a data store comprising interactive assessment content, performance content, compliance content, and recorded interactive assessment session content; and
an interactive assessment engine operable on the data store to monitor, track, and score in real-time one or more electronic interactions between a participating user and a cooperating party,
wherein the interaction comprises the execution of one or more selected procedures by a participating user to show the aptitude and/or skill of the participating user in executing the one or more selected procedures.

12. The system as recited in claim 11 wherein the cooperating party comprises a role player playing a role defined by one or more selected model scenarios.

13. The systems as recited in claim 11 wherein the interactive assessment content of the data store comprises data representative of one or more selected model scenarios.

14. The system as recited in claim 13 where the interactive assessment engine can deliver electronically to a participating user over a computing environment interactive learning content prior to and/or after the completion of an interactive assessment session.

15. The system as recited in claim 14 further comprising a computing environment.

16. The system as recited in claim 15 further comprising a networked computing environment.

17. The system as recited in claim 16 further wherein the interactive assessment engine comprises a computing application operating on the computing environment.

18. The system as recited in claim 17 further comprising a graphical user interface operable to receive input data for communication to the interactive assessment engine.

19. The system as recited in claim 18 wherein the inputted data comprises data representative of a request to initiate an interactive learning/assessment session.

20. The system as recited in claim 19 wherein the graphical user interface is operable on the computing environment to display interactive learning/assessment content.
